(19) United States
(12) Patent Application Publication
(10) Pub. No.: US 2026/0300460 A1
(43) Pub. Date: Oct. 1, 2026

(54) SECURITY SYSTEM FOR USER AUTHENTICATION USING CONTEXTUAL INTERPRETATION OF ABSTRACT SHAPES

(71) Applicant: BANK OF AMERICA CORPORATION, Charlotte, NC (US)

(72) Inventors: Maharaj Mukherjee, Poughkeepsie, NY (US); George Anthony Albero, Charlotte, NC (US)

(73) Assignee: BANK OF AMERICA CORPORATION, Charlotte, NC (US)

(21) Appl. No.: 19/092,063

(22) Filed: Mar. 27, 2025

(51) Int. Cl. G06F 21/36

(52) U.S. Cl. CPC G06F 21/36

(57) ABSTRACT

Systems, computer program products, and methods are described herein for improved user authentication in a computing environment using image-based authentication prompts. In various embodiments, a generation subsystem may be configured to generate an authentication prompt in response to a request to access computing resources. The authentication prompt may comprise an amorphous shape and a task associated with the amorphous shape. The generation subsystem may further be configured to transmit the authentication prompt to an end-point device. A validation subsystem, operatively coupled to the generation subsystem, may be configured to receive an authentication response from the end-point device and validate the authentication response. An authentication subsystem, operatively coupled to the validation subsystem, may be configured to permit access to the computing resources in an instance in which the authentication response is determined to be valid.

### TECHNOLOGICAL FIELD

Example embodiments of the present disclosure relate to computer security systems, and more specifically, to human verification mechanisms designed to resist automated solution by artificial intelligence (AI) models.

### BACKGROUND

CAPTCHA (Completely Automated Public Turing test to tell Computers and Humans Apart) systems are widely used to distinguish human users from automated agents. These systems are typically deployed in digital interfaces to prevent unauthorized automated access to online resources. Conventional CAPTCHA implementations rely on human abilities to recognize distorted alphanumeric characters, solve basic logic problems, or identify objects in images.

Recent advances in machine learning, particularly in the domains of computer vision and generative artificial intelligence, have significantly diminished the effectiveness of conventional CAPTCHA systems. Modern AI models exhibit high proficiency in recognizing distorted text, identifying objects in complex visual scenes, and solving pattern-based problems that were previously assumed to be difficult for automated systems. As a result, there exists a growing need for CAPTCHA mechanisms that present challenges uniquely suited to human cognitive and perceptual abilities, but remain difficult for AI systems to overcome.

Applicant has identified a number of deficiencies and problems associated with a security system for user authentication. Many of these identified problems have been solved by developing solutions that are included in embodiments of the present disclosure, many examples of which are described in detail herein.

### BRIEF SUMMARY

Systems, methods, and computer program products are provided for a security system for user authentication using contextual interpretation of abstract shapes.

In one aspect, a system for improved user authentication in a computing environment is presented. The system comprising: a generation subsystem, wherein the generation subsystem is configured to: generate an authentication prompt in response to a request to access computing resources, wherein the authentication prompt comprises an amorphous shape, and a task associated with the amorphous shape; and transmit the authentication prompt to an end-point device; a validation subsystem operatively coupled to the generation subsystem, wherein the validation subsystem is configured to: receive, from the end-point device, an authentication response to the authentication prompt; and validate the authentication response; and an authentication subsystem operatively coupled to the validation subsystem, wherein the authentication subsystem is configured to: permit access to the computing resources in an instance in which the authentication response is valid.

In some embodiments, the system further comprises a request-handling subsystem, wherein the request-handling subsystem is configured to: receive, from the end-point device, the request to access the computing resources.

In some embodiments, the task associated with the amorphous shape comprises a shape matching task requiring selection of a visually similar amorphous shape from a plurality of candidate shapes, wherein each of the candidate shapes lacks defined boundaries or repeatable patterns.

In some embodiments, the validation subsystem is further configured to: receive a user selected shape in response to the authentication prompt; compute a similarity score between the user selected shape and the amorphous based on non-geometric visual features; and validate the authentication response if the similarity score satisfies a threshold criterion.

In some embodiments, the task associated with the amorphous shape comprises an object recognition task requiring identification of a shape that visually resembles a familiar object, wherein the amorphous shape lacks a consistent geometric structure.

In some embodiments, the validation subsystem is further configured to: receive a user identified shape in response to the authentication prompt; and compare the user identified shape to the amorphous shape using a perceptual resemblance model; and validate the authentication response based on proximity to expected human selection patterns.

In some embodiments, the authentication prompt comprises a plurality of overlapping amorphous shapes, and wherein the task associated with the plurality of overlapping amorphous shapes comprises a segmentation challenge requiring delineation of one or more boundaries between the plurality of overlapping amorphous shapes.

In some embodiments, the validation subsystem is further configured to: receive a user-drawn segmentation path in response to the authentication prompt; compare the user-drawn segmentation to known boundary regions; and validate the authentication response based on positional correspondence between the user-drawn segmentation path and the known boundary regions.

In some embodiments, the authentication prompt comprises a dynamically changing amorphous shape, and wherein the task associated with the dynamically changing amorphous shape comprises identifying a sub-region within the dynamically changing amorphous shape.

In some embodiments, the validation subsystem is further configured to: receive a user-selected sub-region within the dynamically changing amorphous shape in response to the authentication prompt; analyze spatial coordinates of the user-selected sub-region; and validate the authentication response if the user-selected sub-region corresponds to a persistently recognizable feature.

In some embodiments, the dynamically changing amorphous shape is represented as a sequence of frames, and wherein analyzing the spatial coordinates comprises analyzing across the sequence of frames.

In some embodiments, the task comprises predicting a subsequent state of the dynamically changing amorphous shape based on a time-sequenced presentation of prior shape transitions.

In some embodiments, the validation subsystem is further configured to: receive a user-predicted shape state in response to the authentication prompt; compare the user-predicted shape state to one or more pre-computed future states generated using a shape transformation model; and validate the authentication response if the user-predicted shape state matches the one or more pre-computed future states within a tolerance range.

In some embodiments, the task comprises ranking a set of amorphous shapes based on perceptual similarity to the amorphous shape.

In some embodiments, the validation subsystem is further configured to: receive a user ranking of the set of amorphous shapes in response to the authentication prompt; assess the user ranking against an expected ordering derived from aggregated human input; and validate the authentication response based on a degree of concordance between the user ranking and the expected ordering.

In some embodiments, the task comprises tracing a continuous contour within the amorphous shape, wherein the amorphous shape contains visually entangled regions.

In some embodiments, the validation subsystem is configured to: receive a user-traced contour in response to the authentication prompt; evaluate the user-traced contour against a reference path using tolerance-based path similarity metrics; and validate the authentication response if the traced contour aligns with an expected trajectory.

In another aspect, a computer program product for improved user authentication in a computing environment is presented. The computer program product comprising a non-transitory computer-readable medium comprising code, which when executed, is configured to cause a processing device to: generate, using a generation subsystem, an authentication prompt in response to a request to access computing resources, wherein the authentication prompt comprises an amorphous shape, and a task associated with the amorphous shape; and transmit, using the generation subsystem, the authentication prompt to an end-point device; receive, using a validation subsystem, an authentication response to the authentication prompt from the end-point device; validate, using the validation subsystem, the authentication response; and permit, using an authentication subsystem, access to the computing resources in an instance in which the authentication response is valid.

In yet another aspect, a method for improved user authentication in a computing environment is presented. The method comprising: generating, using a generation subsystem, an authentication prompt in response to a request to access computing resources, wherein the authentication prompt comprises an amorphous shape, and a task associated with the amorphous shape; and transmitting, using the generation subsystem, the authentication prompt to an end-point device; receiving, using a validation subsystem, an authentication response to the authentication prompt from the end-point device; validating, using the validation subsystem, the authentication response; and permitting, using an authentication subsystem, access to the computing resources in an instance in which the authentication response is valid.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for a security system for user authentication, in accordance with an embodiment of the invention; and

FIG. 2 illustrates a process flow for a security system for user authentication, in accordance with an embodiment of the invention.

### DETAILED DESCRIPTION

### Overview

Conventional CAPTCHA systems frequently utilize character recognition, image classification, or simple pattern analysis to differentiate between human users and automated agents. These approaches are increasingly susceptible to compromise due to advancements in machine learning and computer vision. High-accuracy image recognition models are now capable of solving traditional CAPTCHAs at scale, rendering such methods ineffective for preventing unauthorized automated access.

The technical problem addressed by the disclosed invention is the vulnerability of existing CAPTCHA systems to machine learning-based attacks. Specifically, conventional CAPTCHAs exhibit structured, repetitive, or classifiable features that are readily interpretable by trained AI models. These models use regularities in alphanumeric characters, object boundaries, and visual patterns, leading to reduced efficacy in distinguishing human users from automated agents.

The disclosed solution introduces a CAPTCHA system based on amorphous visual stimuli—such as irregular, overlapping, or dynamically changing shapes—that lack consistent, classifiable structure. This design uses current limitations in machine learning systems related to context-based reasoning, visual ambiguity, and segmentation of indistinct or blended shapes. By incorporating these irregular visual elements, the system creates verification tasks that remain interpretable by human users but present difficulty for automated agents trained on structured datasets.

In such user authentication security systems, the amorphous-shape CAPTCHA system may have a number of advantages. For instance, implementing such a CAPTCHA system may reduce computational resources by eliminating the need for back-end image classification models to validate AI-generated responses, since ambiguity is built into the challenge design. Additionally, the amorphous-shape CAPTCHA system increases accuracy in human verification by reducing false negatives associated with AI mimicking human behavior, removes reliance on manual CAPTCHA design updates, as amorphous shapes can be procedurally generated or dynamically animated, enabling scalable deployment, and decreases the number of required challenge-response iterations by providing higher-confidence human verification through inherently AI-resistant tests, and enables. Furthermore, the amorphous-shape CAPTCHA system may provide reduced server-side validation complexity, as shape recognition does not require comparison against a fixed label set, lower computational overhead for CAPTCHA generation and evaluation, particularly when using vector-based or procedural graphics, and overall increase speed of verification processes, as users can respond based on subjective visual interpretation without engaging in text entry or detailed object identification.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

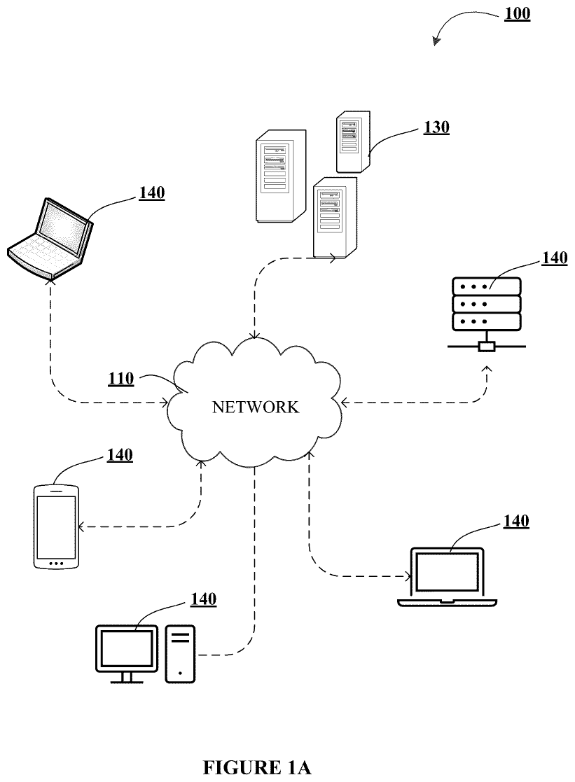

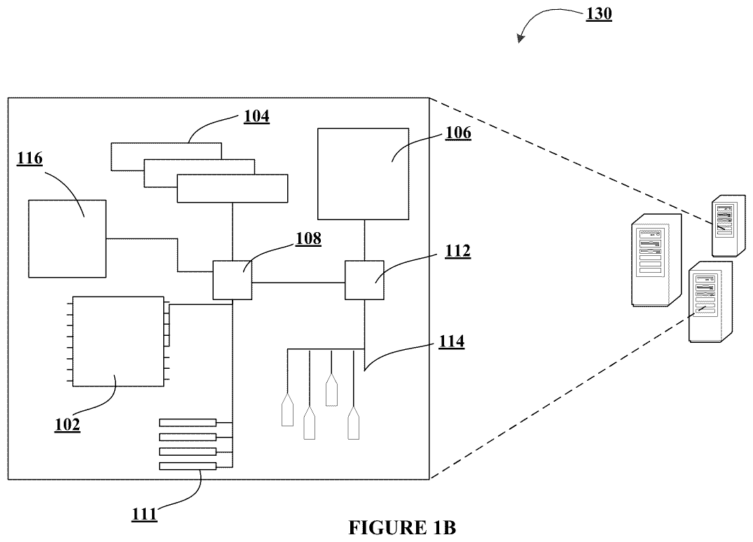

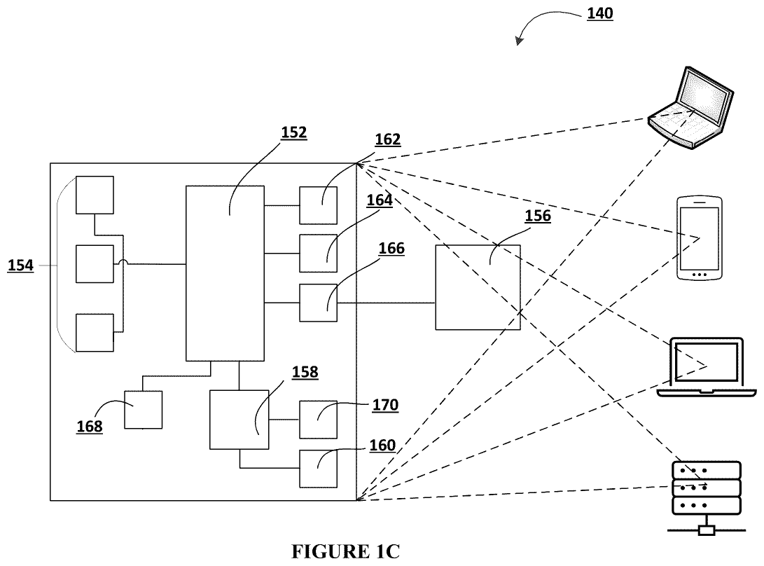

FIGS. 1A-1C illustrate technical components of an exemplary distributed computing environment for a security system for user authentication 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate.

As described herein, the processor 102 may include a number of subsystems to execute the portions of processes described herein. Each subsystem may be a self-contained component of a larger system (e.g., system 130) and capable of being configured to execute specialized processes as part of the larger system. For instance, the generation subsystem may be configured to generate image-based authentication prompts that incorporate amorphous shapes and associated perceptual tasks. The primary function of the generation subsystem is to initiate the authentication workflow by constructing a visual challenge capable of distinguishing human users from automated agents. Upon receipt of a request for access to computing resources, the generation subsystem may execute a prompt-generation routine that includes selecting a task type (e.g., shape matching, segmentation, prediction), generating one or more amorphous shapes, and embedding those shapes within a visual interface suitable for remote display. In this regard, the generation subsystem may include one or more graphical rendering engines, procedural shape generators, animation modules, and logic for task assignment. The generation subsystem may use vector graphics or pixel-based renderers to produce shapes that lack predefined structure or classification, and may apply distortion, layering, or animation techniques to produce ambiguity that challenges machine-based recognition systems. Additionally, the generation subsystem may implement logic for selecting prompt parameters based on system load, user behavior, device capabilities, or threat context. The generation subsystem may interface with a prompt repository, configuration database, or machine-learned model to vary prompt difficulty and structure across sessions. In dynamic prompt embodiments, the generation subsystem may include a timing controller or frame sequence engine to encode animations used in temporal shape prediction tasks.

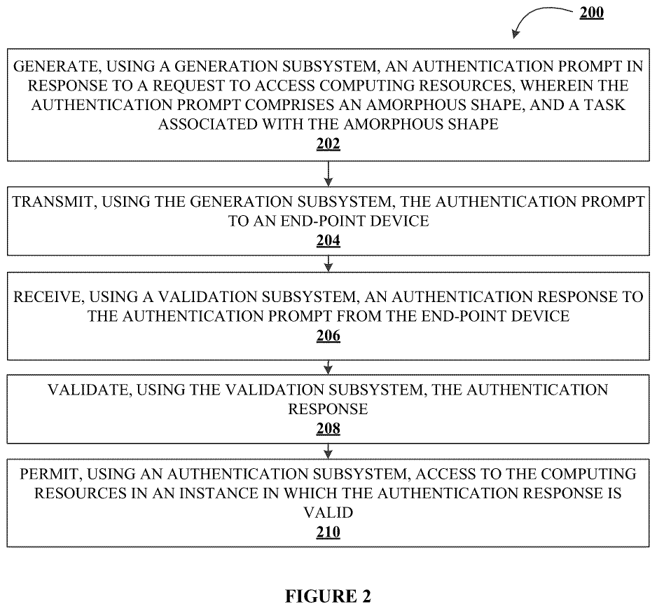

The validation subsystem may be configured to evaluate authentication responses submitted by a user in connection with an image-based authentication prompt. The primary role of the validation subsystem within the system is to determine whether the user response satisfies the criteria associated with the specific perceptual task presented in the prompt. The validation subsystem may be operatively coupled to the generation subsystem and receive both the prompt parameters and the corresponding authentication response. The evaluation process may depend on the type of task associated with the amorphous shape, and may involve a combination of similarity scoring, boundary analysis, perceptual modeling, or sequence prediction, as described in detail in FIG. 2.

The authentication subsystem may be configured to control access to protected computing resources based on the result of the validation performed by the validation subsystem. The primary function of the authentication subsystem is to enforce authentication outcomes and initiate access control actions in response to successful or unsuccessful authentication attempts. The authentication subsystem may receive, for each authentication attempt, a validation result indicating whether the user's response to the image-based authentication prompt meets the task-specific acceptance criteria. Based on this result, the authentication subsystem may determine whether to grant, deny, or defer access to the requested computing resources.

The request-handling subsystem may be configured to receive and process requests from end-point devices seeking access to protected computing resources. The primary role of the request-handling subsystem is to initiate the authentication workflow by detecting access requests and invoking the generation subsystem to produce a corresponding authentication prompt. The request-handling subsystem may also perform preliminary checks before initiating the prompt generation process, such as validating request integrity, verifying session identifiers, or assessing request frequency against rate-limiting thresholds. If the request passes initial screening, the request-handling subsystem may invoke the generation subsystem and pass any associated context necessary to generate a tailored authentication challenge. In some implementations, the request-handling subsystem may interface with access control systems, load balancers, or external authentication providers as part of an integrated security architecture.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

In certain embodiments, the system 130 may be configured to generate and transmit amorphous-shape CAPTCHA challenges to the end-point device(s) 140 via the network 110. These challenges may include static, overlapping, or dynamically changing visual stimuli rendered using vector graphics, animation routines, or randomized shape generation algorithms executed by the processor 102 of the system 130. The memory 104 or storage device 106 of system 130 may store shape templates, generation logic, animation parameters, or user response logs used for issuing, validating, and refining CAPTCHA challenges.

Upon receiving a CAPTCHA challenge, the end-point device(s) 140 may execute rendering instructions using display 156 and processor 152 to present the visual stimuli to the user. The user may interact with the challenge using an input interface (e.g., touchscreen or pointing device) to select or match shapes, delineate boundaries, or predict shape evolution, depending on the specific challenge type. The processor 152 may process the user input and transmit the response to system 130 via communication interface 158 and transceiver 160.

The system 130 may receive the user response and evaluate its correctness based on context-sensitive validation logic. Unlike conventional CAPTCHAs that rely on matching against fixed text strings or image classes, the disclosed system assesses perceptual similarity, segmentation accuracy, or dynamic interpretation using criteria that take advantage of known deficiencies in machine vision systems. Such evaluation may be performed by processor 102 using probabilistic or fuzzy logic, optionally enhanced by adaptive thresholds based on previously recorded user interaction patterns stored in memory 104.

In some implementations, the system 130 may dynamically adjust the difficulty or type of CAPTCHA challenges issued based on metrics derived from response time, input precision, or suspected bot behavior, thus providing a tiered security approach. This adaptivity reduces processing overhead associated with redundant challenges, conserves network bandwidth by optimizing data payloads, and improves the speed of legitimate user access.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

FIG. 2 illustrates a process flow 200 for a security system for user authentication, in accordance with an embodiment of the invention. As shown in block 202, the process flow includes generating, using a generation subsystem, an authentication prompt in response to a request to access computing resources, wherein the authentication prompt comprises an amorphous shape, and a task associated with the amorphous shape. The generation subsystem may be configured to initiate the authentication process upon receipt of a request from an end-point device to access one or more protected computing resources. The generation of the authentication prompt may include retrieving or algorithmically constructing one or more amorphous shapes. An amorphous shape, in this context, may refer to a visual object that lacks regular geometric structure, consistent boundary contours, or semantically defined visual patterns. Such amorphous shapes may be generated procedurally, selected from a pre-existing set, or derived through transformations applied to baseline geometric data.

In addition to the amorphous shape(s), the authentication prompt may include an associated task configured to challenge visual-perceptual capabilities of a human user. These tasks may be selected to leverage ambiguities in shape structure, context-dependent interpretation, and human pattern recognition skills that are not easily replicated by artificial intelligence systems.

In some embodiments, the task may comprise a shape matching challenge, wherein the user is required to select a visually similar amorphous shape from a plurality of candidate shapes. The reference shape and the candidate shapes may be procedurally generated or derived through stochastic transformation processes that remove geometric regularity, such as by altering edge curvature, internal texture, or axis alignment. Each candidate shape may lack defined boundaries, symmetric properties, or consistent patterns, thereby reducing the effectiveness of conventional computer vision classifiers that rely on fixed feature extraction pipelines. The similarity between shapes may be perceptual in nature rather than computationally definable through fixed metrics, making human intuition a more reliable differentiators than algorithmic comparison.

Additionally or alternatively, the task may comprise an object recognition challenge, wherein the amorphous shape is intended to evoke a familiar object—such as a cloud, a flock of birds, or a plume of smoke—despite the absence of consistent geometric structure. In these embodiments, users may be presented with multiple ambiguous shapes and prompted to identify the one that most closely resembles a specified object or concept. Because the shape lacks explicit features such as corners, edges, or textures typically required for machine classification, recognition becomes context-dependent and inherently subjective. The ability of human users to apply analogical reasoning and abstract visual interpretation to such prompts provides a significant barrier to automated systems that lack similar contextual processing capabilities.

In another embodiment, the task may comprise a segmentation challenge involving a prompt that includes a plurality of overlapping amorphous shapes. The user may be asked to delineate one or more boundaries among the blended or intersecting shapes, such as by tracing or selecting contours that separate individual elements. These shapes may be intentionally designed to overlap without clear demarcation, thereby impeding edge detection or segmentation algorithms commonly used in AI systems. Human users, in contrast, may infer boundary lines based on perceived symmetry, texture variation, or continuity cues not easily accessible to current automated systems.

In further embodiments, the task may involve dynamically changing amorphous shapes, presented as animated sequences or frame-based transformations. The transformation may involve morphing, displacement, scaling, or fading of shape elements across time. One task variant may require the user to identify a persistent feature, such as a recognizable sub-region that remains visually stable across frames. Another variant may prompt the user to predict a future state of the shape based on a time-sequenced presentation, which challenges the user's capacity for spatiotemporal reasoning and pattern extrapolation. The difficulty of these tasks arises from the absence of consistent reference points and the unpredictability of transformation rules, which limits the applicability of AI prediction models trained on structured datasets.

Additional task variants may include ranking a set of amorphous shapes based on perceptual similarity to a target shape. The user may be required to order the shapes according to subjective resemblance, which may depend on holistic visual impressions rather than discrete feature comparisons. Alternatively, the user may be asked to perform contour tracing, in which a continuous path is drawn within a visually entangled region of an amorphous shape. These prompts may contain distractor features or noise, increasing complexity and further reducing susceptibility to automated interpretation.

The generation subsystem may include logic for selecting the specific type of authentication challenge to issue based on multiple operational and contextual parameters. In some embodiments, this logic may be implemented as a rule-based engine, decision tree, or machine-learned model stored in a local or distributed non-transitory memory structure and executed by a processing unit.

The selection of a particular task type—such as shape matching, object recognition, segmentation, ranking, or contour tracing—may be determined dynamically based on one or more input conditions. These conditions may include, but are not limited to: the nature of the access request, the type of end-point device initiating the request, previously observed user behavior (e.g., response time or accuracy in prior challenges), historical authentication results, or prevailing system load and processing availability.

For example, if prior user responses exhibit low error rates in shape matching tasks but inconsistent results in segmentation tasks, the generation subsystem may weight the selection toward segmentation-based prompts to improve authentication confidence. Alternatively, under high server load, the system may preferentially generate task types that require reduced backend validation complexity, such as static visual ranking over dynamic animation tracking.

In some embodiments, the generation subsystem may incorporate a feedback mechanism that adapts challenge selection over time. For instance, it may track the success rate of specific challenge types across a population of users or device classes and adjust the distribution of prompts accordingly.

To mitigate predictability and resist automation by machine learning-based CAPTCHA solvers, the generation subsystem may include randomization or procedural variation techniques. This may include altering color palettes, deformation parameters, noise patterns, animation trajectories, or presentation timing within or across amorphous shapes. The system may also introduce visual distractors or decoys that conform to the general visual outline of target shapes but are designed to test decision-making under ambiguity.

The selection logic may also be responsive to external signals or system policies, such as elevated threat detection alerts, time-of-day rules, or geolocation-based access outlines. In such cases, the generation subsystem may escalate challenge difficulty or switch to task types with higher perceptual load, thereby contributing to the overall security posture of the system.

As shown in block 204, the process flow includes transmitting, using the generation subsystem, the authentication prompt to an end-point device. Once the authentication prompt comprising the amorphous shape and associated task is generated, the generation subsystem may be configured to transmit the prompt to an end-point device over a communication network (e.g., network 110). The transmission may utilize standard networking protocols (e.g., TCP/IP, HTTPS) and may be formatted in a manner suitable for rendering by the client-side application executing on the end-point device.

The generation subsystem may be configured to deliver the prompt in real time or near real time, depending on the latency requirements of the underlying authentication workflow. The prompt may be delivered as a rasterized image, a vector-based rendering, a serialized animation, or an encoded frame sequence, depending on the selected task type. In some cases, interactive elements—such as shape selection tools, segmentation paths, or contour tracing interfaces—may be included in the prompt payload to support user interaction with the amorphous shape.

As shown in block 206, the process flow includes receiving, using a validation subsystem, an authentication response to the authentication prompt from the end-point device. After the user is presented with an authentication prompt comprising an amorphous shape and an associated perceptual task, the user's interaction with the prompt generates an authentication response, which may be transmitted from the end-point device to the validation subsystem. The form and content of the authentication response may vary based on the specific type of task presented in the prompt.

For instance, in shape matching tasks, the user is presented with a reference amorphous shape and a set of candidate shapes. The user must select the candidate shape that most closely resembles the reference. The authentication response may comprise a selection indicator corresponding to the selected candidate shape, such as a shape ID, index value, or coordinate reference within a graphical interface. The response may also include ancillary metadata such as interaction time and click location to support behavioral analysis.

In object recognition tasks, the user is asked to interpret an amorphous shape as resembling a familiar object (e.g., a cloud or smoke plume). The response may include a categorical selection (e.g., “cloud”, “flock of birds”, “smoke”) from a predefined set of options, or may involve freeform labeling via text input or gesture-based selection. Alternatively, the interface may display multiple amorphous shapes and prompt the user to choose the one most representative of a described object, in which case the response structure may resemble that of the shape matching task.

In segmentation challenges, the prompt contains overlapping amorphous shapes. The user must delineate one or more boundaries between the shapes. The authentication response may include a sequence of coordinate pairs (x, y) representing a drawn segmentation path or boundary. In graphical implementations, this may take the form of a polyline, Bézier curve, or raster mask. Additional response data may include stroke order, duration, or pressure data (e.g., for touchscreen input), allowing the system to evaluate the interaction with greater granularity.

In dynamic feature identification tasks, the prompt presents a shape that changes over time—either as an animation or a frame sequence. The user must identify a stable or persistent sub-region. The response may include the bounding coordinates of the selected region, an identifier for a graphical element if discrete layers are used, or temporal data indicating at which frame the selection occurred. In some embodiments, the response may include a sequence of selections across multiple frames to track a feature over time.

In a shape state prediction task, the user observes a series of transformations applied to an amorphous shape and is asked to predict the subsequent state. The response may include a selection from multiple predicted outcome shapes or a drawing/input representing the user's predicted continuation. If the prediction is selected from a set, the response may mirror the format of a shape matching task. If the prediction is generated manually (e.g., via sketch input), the response may include vector or raster data representing the predicted form.

In a shape ranking task, the user is asked to order a set of amorphous shapes based on their perceived similarity to a reference shape. The response may be represented as an ordered list of identifiers (e.g., shape IDs or position indexes) submitted by the user. This list may be evaluated for concordance with expected human ranking patterns. The system may also record interaction details such as drag-and-drop sequences or time spent on each comparison.

In a contour tracing task, the user is asked to trace a continuous contour within a visually entangled amorphous shape. The response may consist of path data captured from user input, such as a sequence of (x,y) coordinates or a vector-based representation (e.g., SVG path format). Depending on the input modality, the response may include pressure sensitivity, stroke direction, or path closure information. This data may be compared to a known reference path or evaluated based on structural features such as curvature, inflection points, or continuity.

For all response types, the validation subsystem may also capture auxiliary interaction data, including response latency, cursor motion patterns, device characteristics, or session metadata. The auxiliary interaction data may support further evaluation regarding the likelihood that the interaction originated from a human user versus an automated process.

As shown in block 208, the process flow includes validating, using a validation subsystem, the authentication response. Once the authentication response is received from the end-point device, the validation subsystem may be configured to evaluate the response based on task-specific criteria. These criteria may be predefined, probabilistic, or dynamically computed using perceptual similarity models or human-derived reference data. The validation subsystem may implement the evaluation using algorithms, heuristic rules, threshold logic, or machine-learned models.

The validation methods may vary depending on the type of task presented in the authentication prompt. For instance, in shape matching tasks, the validation subsystem may receive a user-selected shape identifier and compute a similarity score between the selected shape and the reference shape using non-geometric visual features such as texture gradients, curvature flow, or silhouette structure. If the computed similarity score exceeds a predefined threshold, the response may be considered valid. The similarity threshold may be adaptively modified based on system policies or aggregate user performance metrics.

In object recognition tasks, the validation subsystem may compare the user-selected object category to a set of acceptable categories associated with the amorphous shape. This comparison may be based on perceptual resemblance models trained using crowdsourced or curated datasets. Perceptual resemblance models refer to computational systems or algorithms designed to approximate human visual perception when evaluating the similarity or recognizability of shapes, patterns, or images. Perceptual resemblance models do not rely solely on geometric or pixel-wise comparisons, but instead attempt to simulate the way humans intuitively assess visual resemblance, often incorporating features such as overall form, texture, proportion, and spatial relationships. These models often extract mid-level or high-level visual features (e.g., edges, contours, region salience) that correspond to how humans recognize objects in noisy or ambiguous inputs. Unlike rigid shape-matching, they allow for flexibility in deformation, occlusion, or lack of symmetry. Some perceptual resemblance models are trained using datasets annotated by humans, where labels reflect subjective judgments of similarity. The model learns to correlate raw visual data with human perception patterns. Perceptual resemblance models may incorporate principles from perceptual psychology—such as proximity, continuity, or closure—to quantify resemblance in ways that align with human intuition rather than algorithmic precision. Examples of such models may include neural networks trained on human-labeled similarity tasks (e.g., Siamese networks for visual similarity), embedding models where amorphous shapes are mapped into a perceptual feature space, probabilistic models that estimate the likelihood of a human identifying one shape as similar to another, and/or the like. The system may accept a range of plausible interpretations, reflecting the inherently ambiguous nature of the shape. The response may be validated based on statistical proximity to expected human responses, measured using agreement metrics such as cosine similarity or rank correlation.

In segmentation challenges, when the user submits a segmentation path delineating overlapping amorphous shapes, the validation subsystem may compare the user-drawn path to one or more reference boundaries. The comparison may use positional correspondence metrics such as Hausdorff distance or intersection-over-union (IoU). A response may be accepted if the deviation between the user path and the reference boundary falls within a predefined tolerance range.

For responses involving selection of a stable feature in a dynamically changing shape, the validation subsystem may analyze the spatial coordinates of the selected sub-region across multiple frames. The system may validate the response if the selected region coincides with a feature that exhibits low spatial variance across the sequence. In some embodiments, the system may account for minor temporal misalignment or user error by allowing margin-based scoring.

In shape state prediction tasks, the validation subsystem may compare the user-predicted shape state to one or more precomputed future states generated using a shape transformation model. A shape transformation model is a computational model that simulates or predicts the evolution of a shape over time or under transformation operations. These transformations may involve spatial deformation, topological change, scaling, translation, rotation, or time-based morphing. The shape transformation models may be used to generate sequence of shape changes, predict future shape configurations from prior states, validate user responses that anticipate such transitions, and/or the like. Shape transformation models may include parametric models—apply continuous mathematical functions (e.g., spline deformation, affine transformation) to modify shape geometry in a controlled manner, physics-based models—simulate material-like behavior (e.g., fluid dynamics, elasticity) to deform shapes over time in a realistic fashion, procedural models—use rule sets, noise functions, or stochastic processes to apply iterative shape changes, neural or learned models—use machine learning, including recurrent neural networks or autoencoders, to learn transformation patterns from training sequences of amorphous shape changes. As such, a shape transformation model typically takes a source shape or sequence of past shapes as input and produces one or more predicted future shapes as output. The authentication response may be accepted if the user-predicted state falls within a tolerance range defined by acceptable visual or geometric deviation from the model-generated outcome. The comparison may incorporate temporal alignment and deformation metrics.

In shape ranking tasks, the validation subsystem may evaluate the user's submitted shape ranking against a canonical or expected ranking derived from aggregated human input. The validation may apply concordance scoring techniques such as Kendall's Tau or Spearman's rank correlation coefficient. A response may be considered valid if the user's ordering matches or closely approximates the reference order within an allowable error margin.

In contour tracing tasks, the validation subsystem may analyze the traced contour by comparing the user path to a reference trajectory using shape similarity metrics such as dynamic time warping (DTW) or normalized cross-correlation. The authentication response may be accepted if the traced contour aligns with the expected contour within a specified confidence interval. In some embodiments, the system may analyze additional attributes such as drawing direction, continuity, or stroke speed as part of the validation.

In each case, the validation subsystem may also perform secondary analysis on interaction metrics such as response latency, movement smoothness, or atypical input patterns to identify potential automation. These behavioral signals may inform a separate confidence score, which may be used to reinforce or override the primary validation result.

As shown in block 210, the process flow includes permitting, using an authentication subsystem, access to the computing resources in an instance in which the authentication response is valid. Once the authentication response is validated by the validation subsystem according to the criteria associated with the presented task, the validation result is communicated to an authentication subsystem. The authentication subsystem may be configured to determine whether to permit access to protected computing resources based on the outcome of the validation.

If the response is determined to be valid, the authentication subsystem may authorize the user session and allow access to system components, which may include web services, databases, user accounts, secured applications, or other controlled digital environments. Such authorization may be implemented using session tokens, access control lists (ACLs), or identity and access management (IAM) systems integrated within the computing environment. In some embodiments, the authentication subsystem may interface with external security services or credential providers to log the authentication outcome and propagate authorization decisions. The authentication event may also trigger secondary operations such as user description, document-trail logging, or adaptive exposure scoring.

In cases where the validation subsystem determines that the authentication response is invalid, the authentication subsystem may deny access and optionally initiate a fallback process, such as issuing a new authentication prompt of increased difficulty, locking the session after a threshold number of failed attempts, redirecting the user to an alternative verification method, and/or the like.

In some configurations, the authentication subsystem may support tiered access, where partial validation (e.g., borderline similarity scores) results in provisional access with restricted privileges. Additionally, the subsystem may incorporate time-based access control, limiting session duration following successful verification.

As such, the authentication subsystem may operate in coordination with the generation and validation subsystems to close the authentication loop and enforce access policies based on the perceptual verification challenge

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for improved user authentication in a computing environment, the system comprising:
a generation subsystem, wherein the generation subsystem is configured to:
generate an authentication prompt in response to a request to access computing resources, wherein the authentication prompt comprises an amorphous shape, and a task associated with the amorphous shape; and
transmit the authentication prompt to an end-point device;
a validation subsystem operatively coupled to the generation subsystem, wherein the validation subsystem is configured to:
receive, from the end-point device, an authentication response to the authentication prompt; and
validate the authentication response; and
an authentication subsystem operatively coupled to the validation subsystem, wherein the authentication subsystem is configured to:
permit access to the computing resources in an instance in which the authentication response is valid.

2. The system of claim 1, further comprising a request-handling subsystem, wherein the request-handling subsystem is configured to:
receive, from the end-point device, the request to access the computing resources.

3. The system of claim 1, wherein the task associated with the amorphous shape comprises a shape matching task requiring selection of a visually similar amorphous shape from a plurality of candidate shapes, wherein each of the candidate shapes lacks defined boundaries or repeatable patterns.

4. The system of claim 3, wherein the validation subsystem is further configured to:
receive a user selected shape in response to the authentication prompt;
compute a similarity score between the user selected shape and the amorphous based on non-geometric visual features; and
validate the authentication response if the similarity score satisfies a threshold criterion.

5. The system of claim 1, wherein the task associated with the amorphous shape comprises an object recognition task requiring identification of a shape that visually resembles a familiar object, wherein the amorphous shape lacks a consistent geometric structure.

6. The system of claim 5, wherein the validation subsystem is further configured to:
receive a user identified shape in response to the authentication prompt; and
compare the user identified shape to the amorphous shape using a perceptual resemblance model; and
validate the authentication response based on proximity to expected human selection patterns.

7. The system of claim 1, wherein the authentication prompt comprises a plurality of overlapping amorphous shapes, and wherein the task associated with the plurality of overlapping amorphous shapes comprises a segmentation challenge requiring delineation of one or more boundaries between the plurality of overlapping amorphous shapes.

8. The system of claim 7, wherein the validation subsystem is further configured to:
receive a user-drawn segmentation path in response to the authentication prompt;
compare the user-drawn segmentation to known boundary regions; and
validate the authentication response based on positional correspondence between the user-drawn segmentation path and the known boundary regions.

9. The system of claim 1, wherein the authentication prompt comprises a dynamically changing amorphous shape, and wherein the task associated with the dynamically changing amorphous shape comprises identifying a sub-region within the dynamically changing amorphous shape.

10. The system of claim 9, wherein the validation subsystem is further configured to:
receive a user-selected sub-region within the dynamically changing amorphous shape in response to the authentication prompt;
analyze spatial coordinates of the user-selected sub-region; and
validate the authentication response if the user-selected sub-region corresponds to a persistently recognizable feature.

11. The system of claim 10, wherein the dynamically changing amorphous shape is represented as a sequence of frames, and wherein analyzing the spatial coordinates comprises analyzing across the sequence of frames.

12. The system of claim 9, wherein the task comprises predicting a subsequent state of the dynamically changing amorphous shape based on a time-sequenced presentation of prior shape transitions.

13. The system of claim 12, wherein the validation subsystem is further configured to:
receive a user-predicted shape state in response to the authentication prompt;
compare the user-predicted shape state to one or more pre-computed future states generated using a shape transformation model; and
validate the authentication response if the user-predicted shape state matches the one or more pre-computed future states within a tolerance range.

14. The system of claim 1, wherein the task comprises ranking a set of amorphous shapes based on perceptual similarity to the amorphous shape.

15. The system of claim 14, wherein the validation subsystem is further configured to:
receive a user ranking of the set of amorphous shapes in response to the authentication prompt;
assess the user ranking against an expected ordering derived from aggregated human input; and
validate the authentication response based on a degree of concordance between the user ranking and the expected ordering.

16. The system of claim 1, wherein the task comprises tracing a continuous contour within the amorphous shape, wherein the amorphous shape contains visually entangled regions.

17. The system of claim 16, wherein the validation subsystem is configured to:
receive a user-traced contour in response to the authentication prompt;
evaluate the user-traced contour against a reference path using tolerance-based path similarity metrics; and
validate the authentication response if the traced contour aligns with an expected trajectory.

18. A computer program product for improved user authentication in a computing environment, the computer program product comprising a non-transitory computer-readable medium comprising code, which when executed, is configured to cause a processing device to:
generate, using a generation subsystem, an authentication prompt in response to a request to access computing resources, wherein the authentication prompt comprises an amorphous shape, and a task associated with the amorphous shape; and
transmit, using the generation subsystem, the authentication prompt to an end-point device;
receive, using a validation subsystem, an authentication response to the authentication prompt from the end-point device;
validate, using the validation subsystem, the authentication response; and
permit, using an authentication subsystem, access to the computing resources in an instance in which the authentication response is valid.

19. The computer program product of claim 18, wherein the task associated with the amorphous shape comprises a shape matching task requiring selection of a visually similar amorphous shape from a plurality of candidate shapes, wherein each of the candidate shapes lacks defined boundaries or repeatable patterns.

20. A method for improved user authentication in a computing environment, the method comprising:
generating, using a generation subsystem, an authentication prompt in response to a request to access computing resources, wherein the authentication prompt comprises an amorphous shape, and a task associated with the amorphous shape; and
transmitting, using the generation subsystem, the authentication prompt to an end-point device;
receiving, using a validation subsystem, an authentication response to the authentication prompt from the end-point device;
validating, using the validation subsystem, the authentication response; and
permitting, using an authentication subsystem, access to the computing resources in an instance in which the authentication response is valid.
